(19) United States
(12) Patent Application Publication
(10) Pub. No.: US 2008/0258025 A1
(43) Pub. Date: Oct. 23, 2008

(54) Ladder bracket system for window cleaning

(76) Inventor: Mark Rice, Portage, WI (US)

Correspondence Address: QUARLES & BRADY LLP, 411 E. WISCONSIN AVENUE, SUITE 2040, MILWAUKEE, WI, 53202-4497, US

(21) Appl. No.: 12/059,370

(22) Filed: Mar. 31, 2008

Related U.S. Application Data
(60) Provisional application No. 60/913,405, filed on Apr. 23, 2007.

(51) Int. Cl. E06C 7/14

(52) U.S. Cl. 248/210

(57) ABSTRACT

A window support structure for supporting a window during a window cleaning process includes a ladder having a plurality of steps and at least two ladder bracket assemblies. The ladder bracket assemblies include a first bracket configured to removably engage a selected step of the plurality of steps of the ladder. The ladder bracket assemblies also include a mounting flange extending from the bracket beyond the selected step of the ladder to receive a base of a window thereon and arrange a top of the window to rest against the ladder. The ladder bracket assemblies may also include a lower bracket for supporting a trough such that, when a liquid is applied to the window during a window cleaning process, the trough may receive the liquid from the window.

### REFERENCE TO RELATED APPLICATIONS

This application claims the benefit of U.S. Provisional Patent Application No. 60/913,405 filed on Apr. 23, 2007, and entitled “Ladder Bracket System for Window Cleaning.” The contents of the above application is incorporated herein by reference in entirety.

### STATEMENT REGARDING FEDERALLY SPONSORED RESEARCH OR DEVELOPMENT

Not applicable.

### BACKGROUND OF THE INVENTION

The present invention relates generally to window cleaning systems and, more particularly, to an adaptable window cleaning system that can utilize a traditional A-frame stepladder or other structure as a support structure for the window cleaning system.

Professional window cleaners often remove storm windows and other removable windows from a building in order to facilitate cleaning. The windows are often placed on the floor, leaned against a wall or piece of furniture, or supported by hand while being cleaned. To clean the window, a soap solution is applied to the window and then immediately removed with a squeegee. Hence, the used, and dirty, solution is caused to drip from the bottom of the window during the cleaning process. Accordingly, a rug, rags, or other floor covering is typically placed under the window to catch and absorb any runoff from the cleaning process.

There are several problems with cleaning windows as described above. First, if the window cleaner doesn't protect the floor properly from the dirty solution, a considerable amount of discarded and dirty solution can collect around the cleaning area that can damage the floor or, at the very least, require cleaning of the surrounding area after the window-cleaning processes has been completed. Second, if a rug, rags, or other floor coverings are used by the window cleaner, these coverings quickly become saturated and require frequent replacement in order to contain and collect the discarded solutions. The process of collecting, replacing, and cleaning floor coverings results in additional time on the job and reduces productivity and profitability for the window cleaner. Third, placing the window on the floor requires the window cleaner to sit or kneel on the ground to clean the windowpane. Bending down to clean each window requires undue physical effort and, over time, presents a significant stress on the window cleaner's muscles and knees. Furthermore, when the window is resting on the floor, the window cleaner cannot finish the squeegee stroke using a downward motion because the squeegee handle will hit the floor before the rubber squeegee blade reaches the bottom of the windowpane. As such, a final sideways squeegee motion is needed to clean the bottom section of the windowpane. This takes additional time, which further reduces productivity and profitability.

Accordingly, some have sought to develop stands and other window support systems. However, these dedicated stands and support systems are relatively expensive. Furthermore, while the stands or support systems may fold or otherwise collapse to some degree, they take up a large amount of space in the window cleaner's vehicle. Additionally, while some stands and other support systems include collection systems for receiving the dirty solution from the window, they can interfere with the cleaning process. That is, the collection systems are generally located at the base of the window and, in a manner similar to resting the window on the floor, can interfere with the downward stroke of the squeegee handle. In addition, due to repeated use and the weight of the windows resting on the collection system, over time the collection system can break which then requires replacement.

Therefore, it would be desirable to have a system and method for supporting a window during a window cleaning process that would be economically and work-flow efficient.

### BRIEF SUMMARY OF THE INVENTION

The present invention overcomes the aforementioned drawbacks by providing an adaptable window cleaning system that can utilize a traditional A-frame stepladder or other structure as a support structure for the window cleaning system.

In accordance with one aspect of the present invention, a window support structure for supporting a window during a window cleaning process is disclosed that includes a ladder having a plurality of steps and at least two ladder bracket assemblies. The ladder bracket assemblies include a first bracket configured to removably engage a selected step of the plurality of steps of the ladder. The ladder bracket assemblies also include a mounting flange extending from the bracket beyond the selected step of the ladder to receive a base of a window thereon and arrange a top of the window to rest against the ladder.

In accordance with another aspect of the present invention, a kit for retrofitting a ladder to create a window support structure is disclosed that includes at least two ladder bracket assemblies. The ladder bracket assemblies include a first bracket configured to removably engage a selected step of the ladder and a mounting flange extending from the bracket beyond the selected step of the ladder to support a window thereon for a window cleaning process. The ladder bracket assemblies also include a horizontal adjustment system configured to adjust a width of the ladder bracket assembly to match a width of the selected step and a vertical adjustment system configured to adjust a height of the ladder bracket assembly to match a height of the selected step.

In accordance with yet another aspect of the invention, a window support system for supporting a window on a ladder during a window cleaning process is disclosed that includes a bracket configured to removably engage a step of the ladder. The window support system also includes a mounting flange extending from the bracket beyond the step of the ladder to support a base of the window thereon and arrange a top of the window to rest against the ladder.

Various other features of the present invention will be made apparent from the following detailed description and the drawings.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a front perspective view of a window support system in accordance with the present invention;

FIG. 2 is a front perspective view of the window support system of FIG. 1 including a ladder bracket assembly, trough, horizontal adjustment system, and a vertical adjustment system;

FIG. 3 is a rear perspective view of the window support system of FIGS. 1 and 2 attached to a stepladder step including the ladder bracket assembly, the horizontal adjustment system, and a vertical adjustment system;

FIG. 4 is side perspective view the ladder bracket assembly of FIGS. 2 and 3; and

FIG. 5 is an exploded, side perspective view of the ladder bracket assembly of FIGS. 2-4.

### DETAILED DESCRIPTION OF THE INVENTION

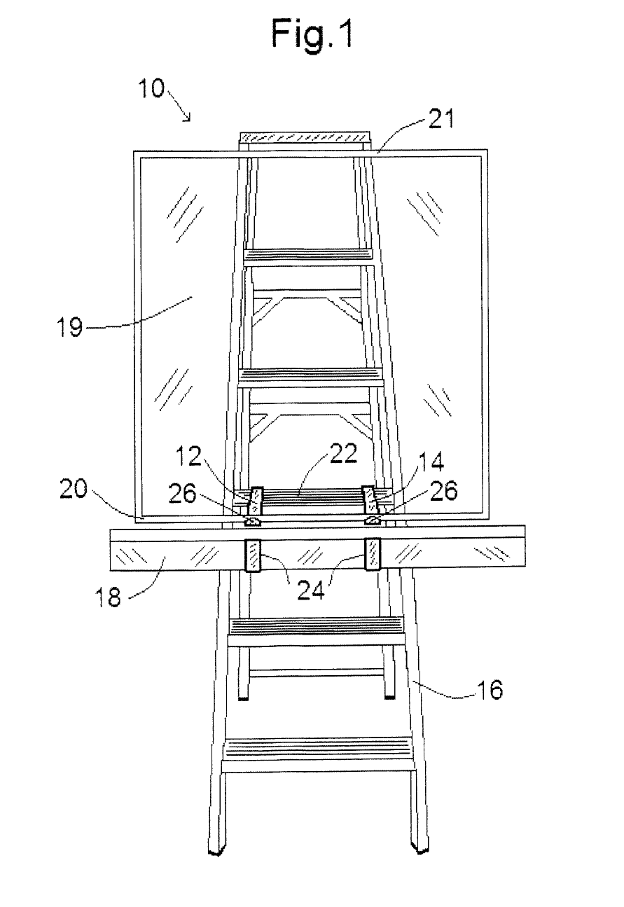

Referring now to FIG. 1, a window support structure 10 includes at least two ladder bracket assemblies 12, 14 that, as illustrated, as supported by a traditional A-frame ladder 16. However, it is contemplated that the present invention is equally applicable for use with other ladders, such as extension ladders, multi-axis folding ladders, and the like. Furthermore, it is contemplated that the present invention may be integrated with other support structures having sufficient structural integrity to support a window and, as will be described below, which the ladder bracket assemblies 12, 14 are capable of engaging. The window support structure 10 also includes a trough 18 that, as will be described below, is designed to receive and collect used or dirty window cleaning solutions from a window 19 supported on the window support system 10. That is a base 20 of the window 19 is supported on the ladder bracket assemblies 12, 14 such that a top 21 of the window 19 rests against the ladder 16.

To convert a traditional ladder 16 into an easel for cleaning windows, the two ladder bracket assemblies 12, 14 are placed on a common step 22 of the ladder 16. A window cleaner may select any step 22 of the ladder 16 to attach the ladder bracket assemblies 12, 14. In this regard, the window cleaner can selectively position the window 19 at a height that is comfortable and ergonomic. Once a vertical position is selected, the window cleaner may arrange ladder bracket assemblies 12, 14 on the selected step 22 at a separation distance as necessary to support the window 19, up to the full width of the step 22. However, the ladder bracket assemblies 12, 14 may be placed closer together on the step 22, if necessary, to accommodate narrow window widths.

As will be described below, it is contemplated that the trough 18 is supported by respective lower brackets 24 of the ladder bracket assembly that extend below respective upper brackets 26, on which the window 19 is designed to rest. In accordance with one embodiment, it is contemplated that the trough 18 may be approximately four feet long; however, longer trough lengths are contemplated to accommodate larger sized windows or to provide a larger reservoir for collecting used or dirty cleaning solution.

After all windows have been cleaned, the trough 18 is removed and, as will be described, the entire bracket assemblies 12, 14 can be easily removed from or repositioned on the ladder 16. Accordingly, the window support structure 10 can be collapsed and stored in the same amount of space as a common ladder. Furthermore, since a window cleaner typically requires a ladder, as will be described, the window support structure 10 presents only a marginal amount of extra space and effort to use.

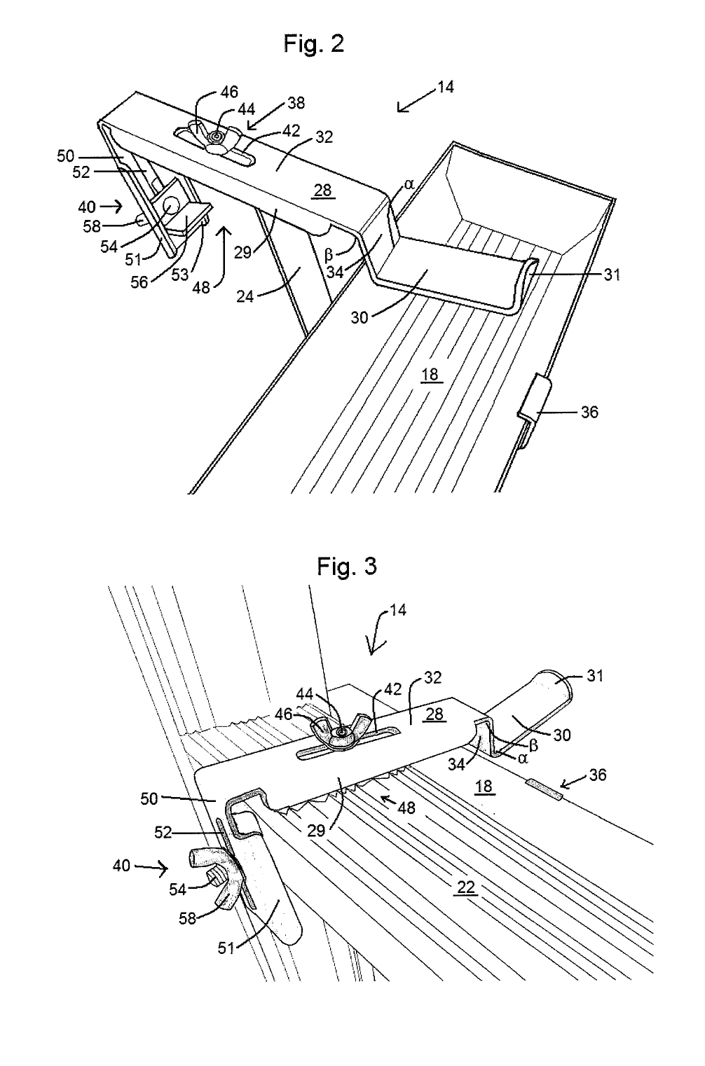

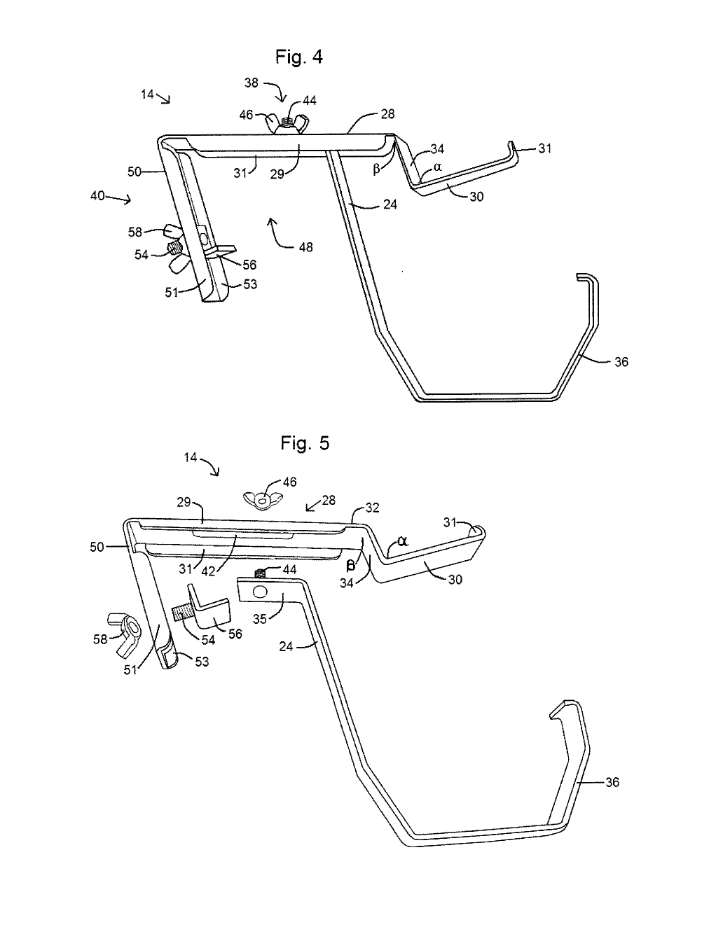

Referring now to FIGS. 2-5, one ladder bracket assembly 14 is shown. The ladder bracket assembly 14 includes a top horizontal adjustment bracket 28 that terminates in a mounting flange 30 that, as will be described, is configured to receive the base of the window 19 and arrange the window 19 to rest against the ladder 16. Specifically, the horizontal adjustment bracket 28 includes an upper bracket portion 32, a backstop 34 extending downward from the upper bracket portion 32, and the mounting flange 30 extending away from the backstop 34. The mounting flange 30 terminates with an upwards turned lip 31 to protect the window from accidentally slipping off the end of the mounting flange 30 during the cleaning process.

In accordance with one aspect of the invention, an angle α is created between the backstop 34 and the mounting flange 30 that is slightly less than 90 degrees, for example, 70 to 80 degrees, to reduce the potential of the window slipping from the mounting flange 30 during the cleaning process and to tilt the window back to rest against the ladder 16. Additionally, or alternatively, the mounting flange 30 may be coated with rubber or other substances to reduce the potential for slipping. Furthermore, an angle β is created between the upper bracket portion 32 and the backstop 34 that, in accordance with one configuration, may be approximately 90 degrees. However, in other configurations, it may be advantageous for angle β to be greater than 90 degrees, in which case the angle α may optionally approach 90 degrees. The mounting flange 30 is designed to have a sufficient length to rest one or more of the typical residential storm window or other removable window thereupon. Therefore, when a window is positioned upon the mounting flange 30, the window can lean against the ladder 16 to engage the top of the window 19 against the upper front side of the ladder 16, as illustrated in FIG. 1.

Extending below the top horizontal adjustment brackets 28 are the lower brackets 24 that form a lower portion 36 of the ladder bracket assemblies 12, 14 designed to hold the trough 18 directly under the top horizontal adjustment bracket 28. The vertical distance between the trough 18 to the bottom of the mounting flange 30 may be a few inches, for example about one to two inches, to allow the bottom of the window to be cleaned without interference from the trough 18. That is, when a window that is to be cleaned is placed on the mounting flange 30, the window is positioned over the trough 18. Given the typical angle of the squeegee when cleaning the window glass, adequate space is provided below the bottom of the window for the window cleaner to finish the downward stroke without the window cleaner's hand or squeegee handle making contact with the trough 18. The horizontal arrangement of the trough 18 in the lower portion 36 relative to the mounting flange 30 is designed to catch the water runoff from the window cleaning process.

The window support structure 10 can be adjusted both vertically and horizontally. That is, as described above, the two ladder bracket assemblies 12, 14 can be engaged with any step on a ladder. Furthermore, as described above, the two ladder bracket assemblies 12, 14 can be arranged along any point on a given step. To facilitate engagement with a selected step of a selected ladder, the two ladder bracket assemblies 12, 14 are highly adjustable.

A horizontal adjustment system 38 is formed at the connection between the top horizontal adjustment brackets 28 and the lower brackets 24. The horizontal adjustment system 38 is formed by two side rails 29, 31 and a slot 42 formed in the upper bracket portion 32 that is designed to receive a bolt 44 extending upward from the upper portion 35 of the lower brackets 24. The two side rails 29, 31 substantially increase the load bearing capacity of the top horizontal adjustment bracket 28 which supports the weight of the window(s) during the window cleaning process. Additionally, the two side rails 29, 31 act as a track to keep the lower brackets 24 aligned with the top horizontal adjustment bracket 28. A nut 46, for example a wing nut, is provided to engage the bolt 44. While the present invention is described with respect to a nut-and-bolt fastening system, it is contemplated that a wide variety of systems and methods for securing two portions of the ladder bracket assembly 12, 14 may be utilized.

The bolt 44 can be moved along the slot 42 to thereby adjust an area 48 provided to receive a ladder step. That is, the bolt 44 can be moved along the slot 42 to adjust the horizontal size of the area 48 to match the step size of a ladder with which the ladder bracket assembly 14 is to be engaged. The nut 46 is then used to secure the horizontal adjustment system 38 in the selected position.

Similarly, a vertical adjustment system 40 is formed at the rear of the top horizontal adjustment bracket 28, opposite the mounting flange 30. The vertical adjustment system 40 is formed by a vertical adjustment flange 50 that extends down from the upper bracket portion 32. The vertical adjustment flange 50 includes two side rails 51, 53 and a slot 52 that, like the slot 42 in the upper bracket portion 32, is configured to receive a bolt 54 extending from a vertical adjustment clip 56. The two side rails 51, 53 act as a track to keep the vertical adjustment clip 56 aligned with the vertical adjustment flange 50. Another nut 58, for example a wing nut, is provided to engage the bolt 54. In this regard, the bolt 54 can be moved along the slot 52 and secured in a selected position by tightening the nut 58. Hence, the vertical adjustment clip 56 can be moved to adjust the vertical size of the area 48 to match the step size of a ladder with which the ladder bracket assembly 14 is to be engaged.

Once the horizontal and vertical adjustment systems 38, 40 have been used to size the two ladder bracket assemblies 12, 14 for a particular ladder, to adjust the horizontal position of the ladder bracket assemblies 12, 14 or to disengage the ladder bracket assemblies 12, 14 from the ladder 16, one only needs to loosen the wing nuts and reverse the installation process. Accordingly, the ladder bracket assemblies 12, 14 can quickly and easily be repositioned on or removed from a given ladder. Hence, the present invention can be quickly and easily setup, reconfigured, and stored.

The present invention has been described according to its various aspects, and it should be appreciated that many equivalents, alternatives, variations, and modifications, aside from those expressly stated, are possible and within the scope of the invention. Therefore, the invention should not be limited to a particular described form.

I claim:

1. A window support structure for supporting a window using a ladder having a plurality of steps during a window cleaning process comprising:
a plurality of ladder bracket assemblies including:
a first bracket configured to removably engage a selected step of the plurality of steps of the ladder; and
a mounting flange extending from the bracket beyond the selected step of the ladder adapted to receive a base of a window thereon and arrange a top of the window to rest against the ladder.

2. The window support structure of claim 1, further comprising a second bracket extending below the mounting flange in at least two of the plurality of ladder bracket assemblies, and configured to support a trough on the second bracket of at least two of the plurality of ladder bracket assemblies below the window such that the trough receives a liquid applied to the window supported on the mounting flange during a window cleaning process.

3. The window support structure of claim 2, wherein the second bracket extends from the first bracket.

4. The window support structure of claim 3, further comprising a horizontal adjustment system configured to secure the second bracket to the first bracket in at least two of the plurality of ladder bracket assemblies.

5. The window support structure of claim 4, further comprising a bolt extending from the second bracket through a slot formed in the first bracket and a nut configured to engage the bolt to secure the second bracket to the first bracket.

6. The window support structure of claim 1, further comprising a backstop connecting the mounting flange to the first bracket in at least two of the plurality of ladder bracket assemblies.

7. The window support structure of claim 6, wherein an angle formed between the mounting flange and the backstop is less than 90 degrees.

8. The window support structure of claim 6, wherein an angle formed between the first bracket and the backstop is greater than 90 degrees.

9. The window support structure of claim 1, further comprising a vertical adjustment flange extending from the first bracket opposite the mounting flange to engage a rear portion of the selected step to removably engage the first bracket to the selected step in at least two of the plurality of ladder bracket assemblies.

10. The window support structure of claim 9, further comprising a clip extending from the vertical adjustment flange that extends under the selected step to removably secure the first bracket to the selected step in at least two of the plurality of ladder bracket assemblies.

11. The window support structure of claim 10, further comprising a slot formed in the vertical adjustment flange, a bolt extending from the clip through the slot, and a nut configured to engage the bolt to secure the clip to the vertical adjustment flange.

12. A kit for retrofitting a ladder to create a window support structure comprising:
a plurality of ladder bracket assemblies including:
a first bracket configured to removably engage a selected step of the ladder;
a mounting flange extending from the bracket beyond the selected step of the ladder to support a window thereon for a window cleaning process;
a horizontal adjustment system configured to adjust a width of the ladder bracket assembly to match a width of the selected step; and
a vertical adjustment system configured to adjust a height of the ladder bracket assembly to match a height of the selected step.

13. The kit of claim 12, further comprising a second bracket extending below the mounting flange in at least two of the plurality of ladder bracket assemblies and a trough configured to be supported by the second bracket below the mounting flange to receive a solution discarded from the window during the window cleaning process.

14. The kit of claim 13, wherein the second bracket is engaged with the first bracket through the horizontal adjustment system.

15. The kit of claim 12, wherein the mounting flange is further configured to support a base of the window thereon and such that a top of the window rests against the ladder when the base of the window is supported by the mounting flange.

16. The kit of claim 12, further comprising a backstop connecting the mounting flange to the first bracket in at least two of the plurality of ladder bracket assemblies.

17. The kit of claim 16, wherein an angle formed between the backstop and at least one of the mounting flange and the first bracket is less than 90 degrees.

18. A window support system for supporting a window on a ladder during a window cleaning process comprising:
a bracket configured to removably engage a step of the ladder; and
a mounting flange extending from the bracket beyond the step of the ladder to support a base of the window thereon and arrange a top of the window to rest against the ladder.

19. The window support system of claim 18, further comprising another bracket extending below the mounting flange and configured to support a trough below the window to receive a liquid applied to the window supported on the mounting flange during the window cleaning process.

20. The window support system of claim 18, further comprising at least one of a horizontal adjustment system and a vertical adjustment system configured to adjust a size of the window support system to match a size of a selected step of a the ladder.
